(19) United States
(12) Patent Application Publication
(10) Pub. No.: US 2015/0142795 A1
(43) Pub. Date: May 21, 2015

(54) CONFIGURABLE MEDIA PROCESSING WITH META EFFECTS

(71) Applicant: Google Inc., Mountain View, CA (US)

(72) Inventors: Thor Carpenter, Kirkland, WA (US); Kai Ding, Sunnyvale, CA (US)

(73) Assignee: Google Inc., Mountain View, CA (US)

(21) Appl. No.: 14/083,415

(22) Filed: Nov. 18, 2013

(51) Int. Cl. G06F 17/30

(52) U.S. Cl. CPC G06F 17/30017
USPC 707/736

(57) ABSTRACT

Systems, methods and computer readable media for configurable media processing with meta effects are disclosed. In some implementations, the systems, methods and computer readable media can process a media file based on one or more meta effects (e.g., an ordered list of effects and their corresponding parameters).

### BACKGROUND

Media (images, video and/or audio) processing systems may often be composed of multiple individual media processing routines arranged to produce layered, combined or other, more complex, media processing routines. These systems may require configuration to specify media processing parameters, order of processing and resource management. The configuration may be difficult or impossible to readily adjust or change “on the fly” or at runtime.

It may be desirable to have a flexible, runtime configurable application programming interface (API) and mechanism for this media processing configuration. Some implementations were conceived in light of the above-mentioned problems and limitations, among other things.

### SUMMARY

Some implementations relate generally to media processing and, more particularly, to configurable media processing with meta effects. Some implementations can include a method. In some implementations, the method can include receiving, at one or more processors, one or more effect identifiers, and generating, at the one or more processors, a meta effect object based on the one or more effect identifiers. The method can also include receiving, at the one or more processors, a media item. The method can further include processing, at the one or more processors, the media item based on the meta effect, including applying an individual effect operation corresponding to each of the one or more effect identifiers to the media item to generate a processed media file, and providing, at the one or more processors, a processed media file as output.

The meta effect object can include a specification of an order in which to apply each effect corresponding to the one or more effect identifiers. An effect identifier can reference another meta effect. The other meta effect can reference an effect identified by one of the effect identifiers.

The method can also include providing, at the one or more processors, a resource manager reference for accessing one or more media objects stored in a cache associated with the resource manager. Each media object in the resource manager cache can be accessible via a key, and the key may be shared among effects, including sub effects of an effect.

The generating can include generating parameters for each effect and including the parameters in the meta effect object. The meta effect object can be a JavaScript Object Notation (JSON) object. The media file includes one or more of a still image, a video file and an audio file.

Some implementations can include a system having one or more processors configured to perform operations. The operations can include receiving one or more effect identifiers, and generating a meta effect object based on the one or more effect identifiers. The operations can also include receiving a media item. The operations can further include processing the media item based on the meta effect, including applying an individual effect operation corresponding to each of the one or more effect identifiers to the media item to generate a processed media file. The operations can also include providing a processed media file as output.

The meta effect object can include a specification of an order in which to apply each effect corresponding to the one or more effect identifiers. An effect identifier can reference another meta effect. The other meta effect can reference an effect identified by one of the effect identifiers. The operations can also include providing, at the one or more processors, a resource manager reference for accessing one or more media objects stored in a cache associated with the resource manager.

Each media object in the resource manager cache can be accessible via a key, and wherein the key may be shared among effects, including sub effects of an effect. The generating includes generating parameters for each effect and including the parameters in the meta effect object, and wherein the meta effect object is a JSON object.

Some implementations can include a nontransitory computer readable medium having software instructions stored thereon that, when executed by a processor, cause the processor to perform operations. The operations can include receiving one or more effect identifiers. The operations can also include generating a meta effect object based on the one or more effect identifiers. The operations can further include receiving a media item, and processing the media item based on the meta effect, including applying an individual effect operation corresponding to each of the one or more effect identifiers to the media item to generate a processed media file. The operations can also include providing a processed media file as output.

The meta effect can include a specification of an order in which to apply each effect corresponding to the one or more effect identifiers, and an effect identifier can be configured to reference another meta effect. Also, the other meta effect can be configured to reference an effect identified by one of the effect identifiers.

The operations can also include providing, at the one or more processors, a resource manager reference for accessing one or more media objects stored in a cache associated with the resource manager. Each media object in the resource manager cache is accessible via a key. The key can be shareable among effects, including sub effects of an effect. The generating can include generating parameters for each effect and including the parameters in the meta effect object. The meta effect object can include a JSON object.

### BRIEF DESCRIPTION OF THE DRAWINGS

FIG. 1 shows an example system for configurable media processing with meta effects in accordance with some implementations.

FIG. 2 is a flow chart for an example configurable media processing with meta effects process in accordance with some implementations.

FIG. 3 is a computing system diagram for configurable media processing with meta effects in accordance with some implementations.

FIG. 4 is a diagram of an example meta effect in accordance with some implementations.

FIG. 5 is a diagram of an example meta effect in accordance with some implementations.

### DETAILED DESCRIPTION

Systems, methods and computer readable media for configurable media processing with meta effects are disclosed. In some implementations, the systems, methods and computer readable media can process a media file based on one or more meta effects (e.g., an ordered list of effects and their corresponding parameters). Effects can include operations performed on a media file, for example effects could include “play audio sample A” or “blur image”. The effects can be applied in a linear manner, one after the other, for each new media item input. For example, if a “blur” effect is selected for operation, for each video frame the system would blur the video frame. In another example, if the system had configured effects “blur” and “overlay icon”, in that order, the system would, for each video frame, first blur the frame then overlay a specified icon.

To create more complicated media processing configurations a “meta effect” can be used. A meta effect can include an effect that contains other effects, (or “sub effects”). A sub effect may be an individual effect or may be a meta effect, in which case a meta effect may contain one or more other meta effects. Meta effects can contain a “pipeline” that specifies the order of the effects to be performed within the meta effect. In general, by defining meta effects as sub effects, and by composing sub effects to form meta effects, a system may inject and compose multiple simple media processing routines into other arbitrarily complex media processing routines.

Meta effects can be generated and sent from a “factory” that has the information on how to create effects from a set of effect identifiers (or IDs). For example, “blur” may be an effect ID that when passed to the factory, the factory creates and returns a blur effect.

Individual effects can be aware of the parameters that can be used to configure each effect. Each effect can be responsible for parsing its own parameters (e.g., sent as a JavaScript Object Notation (JSON) object or other suitable object). Thus, a meta effect can be configured via a simple JSON object. When a meta effect JSON object is parsed, it may in turn create other effects, which in turn recursively parse JSON objects contained within the original JSON object. By performing the configuration in JSON, which can be written as regular text strings, systems can be configured at runtime to create new effects that can include a combination of existing effects. This can permit very quick deployment of new effect configurations to production at a large scale.

In addition, effects can be passed a common “Resource Manager,” which acts as a common cache for media. Each media object in the Resource Manager is accessed by a resource “Key” and keys may be shared amongst effects. This allows effect A to perform intermediate processing and then store the result in the cache with key K, after which effect B may perform processing and combine its results with media stored with key K. Thus, a meta effect may share a common Resource Management object with its sub effects, which can provide a flexible and powerful collaboration of effects.

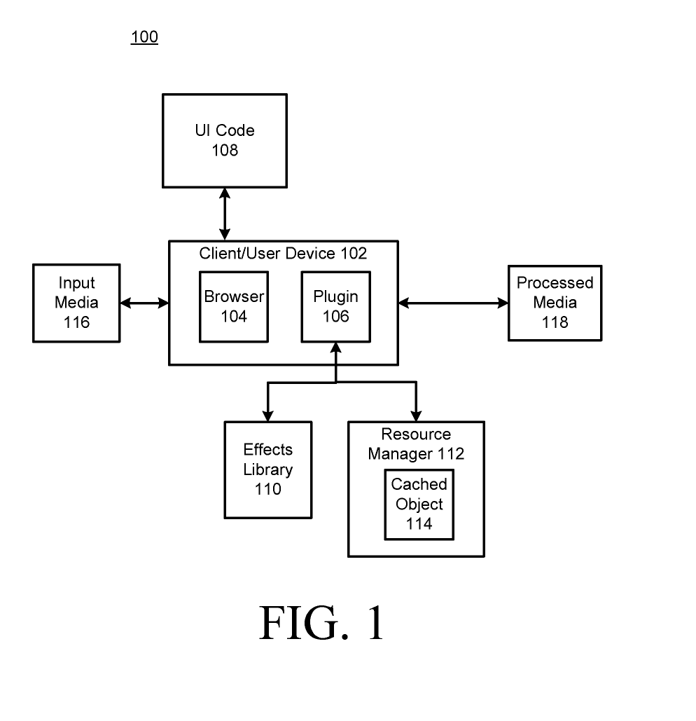

FIG. 1 shows a diagram of an example media processing system 100 including a client/user device 102 having a browser (or other application) 104 and a plugin 106. The system 100 also includes user interface code 108, an effects library 110, a resource manager 112, a cache object 114, an input media item 116 and a processed media item 118.

In operation, the client device 102, via the browser 104 and plugin 106, receives and processes the user interface code 108. The user interface code 108 specifies a one or more effect (or filter) identifiers (IDs) and sequence/parameter information for those effects. The browser 104 (or other script processing API) processes the user interface code 108 and outputs a JSON object representation of a meta effect to the plugin 106. The plugin 106 processes the JSON commands and calls each effect in the meta effect using the parameters supplied in the JSON object and in the sequence set forth in the JSON object. The plugin 106 processes the input media 116 using the meta effect. During the processing, the plugin 106 (and one or more of the effects) may access the effects library 110 and/or a cached media object 114 via the resource manager 112. The plugin 106 generates a processed media file 118.

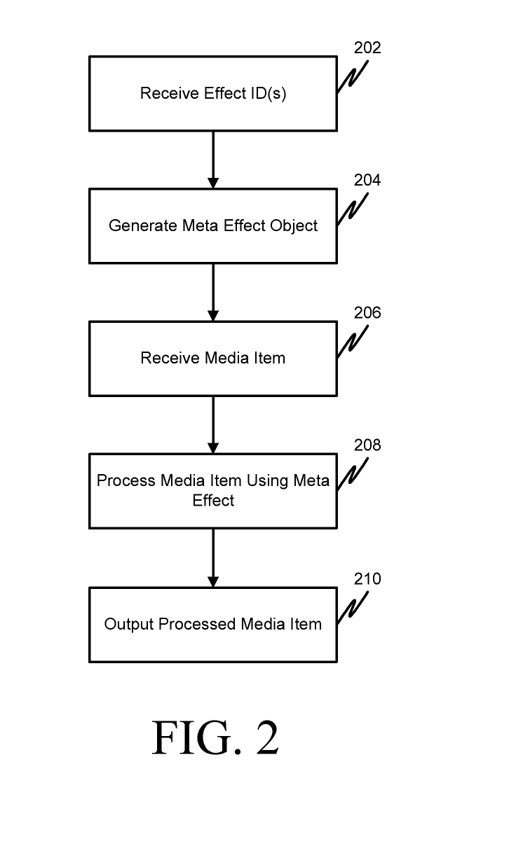

FIG. 2 shows a flow chart of example method for configurable media processing with meta effects. Processing begins at 202, where one or more effect IDs are received. Also, parameters for each effect and a sequence for applying the effects can be received. Effect IDs can correspond to individual effects or other meta effects. Processing continues to 204.

At 204, a meta effect object is generated by a meta effect factory module or system to produce a meta effect object (e.g., a JSON object). The meta effect object can be sent to another application (e.g., a plugin) for executing. Processing continues to 206.

At 206, a media item is received. The media item can include all or a portion of a still image, a video file and/or an audio file. Processing continues to 208.

At 208, the media item is processed according to the meta effect object. For example, the meta effect object can be used to invoke a sequence of effects to perform on the media item using parameters supplied by the meta effect object (e.g., the media item can be processed by a plugin operating in accordance with a meta effect object). Processing continues to 210.

At 210, the processed media item is output by the plugin. Outputting can include one or more of storing in memory, sending to another system, displaying or playing the processed media item or the like. It will be appreciated that 202-210 can be repeated in whole or in part in order to accomplish a contemplated media processing task.

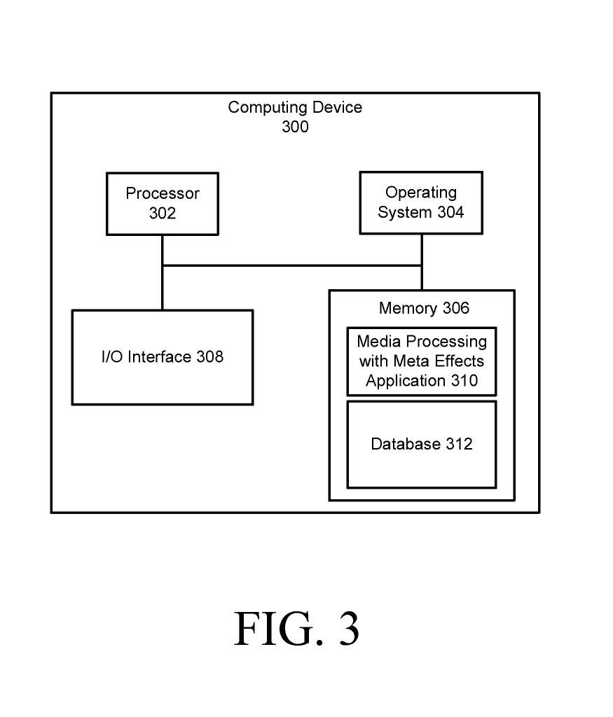

FIG. 3 is a diagram of an example computing device 300 configured for configurable media processing with meta effects in accordance with some implementations. The computing device 300 includes a processor 302, operating system 304, memory 306 and I/O interface 308. The memory 306 can include a configurable media processing with meta effects application 310 and a database 312 (e.g., for storing media items, effects, meta effects or the like).

In operation, the processor 302 may execute the configurable media processing with meta effects application 310 stored in the memory 306. The configurable media processing with meta effects application 310 can include software instructions that, when executed by the processor, cause the processor to perform operations for configurable media processing with meta effects in accordance with the present disclosure (e.g., the configurable media processing with meta effects application 310 can perform one or more of steps 202-210 described above, or 402-420 and/or 502-512 described below and, in conjunction, can access the database 312). The configurable media processing with meta effects application 310 can also operate in conjunction with the operating system 304.

The configurable media processing with meta effects computing device (e.g., 102 and/or 300) can include, but is not limited to, a single processor system, a multi-processor system (co-located or distributed), a cloud computing system, or a combination of the above.

The client (or user) device(s) can include, but are not limited to, a desktop computer, a laptop computer, a portable computer, a tablet computing device, a smartphone, a feature phone, a personal digital assistant, a media player, televisions, an electronic book reader, an entertainment system of a vehicle or the like. Also, user devices can include wearable computing devices (e.g., glasses, watches and the like), furniture mounted computing devices and/or building mounted computing devices.

The user devices can be connected to a configurable media processing server or system via a network (e.g., 120). The network connecting user devices to the configurable media processing server or system can be a wired or wireless network, and can include, but is not limited to, a WiFi network, a local area network, a wide area network, the Internet, or a combination of the above.

The data storage, memory and/or computer readable medium can be a nontransitory medium such as a magnetic storage device (hard disk drive or the like), optical storage device (CD, DVD or the like), or electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

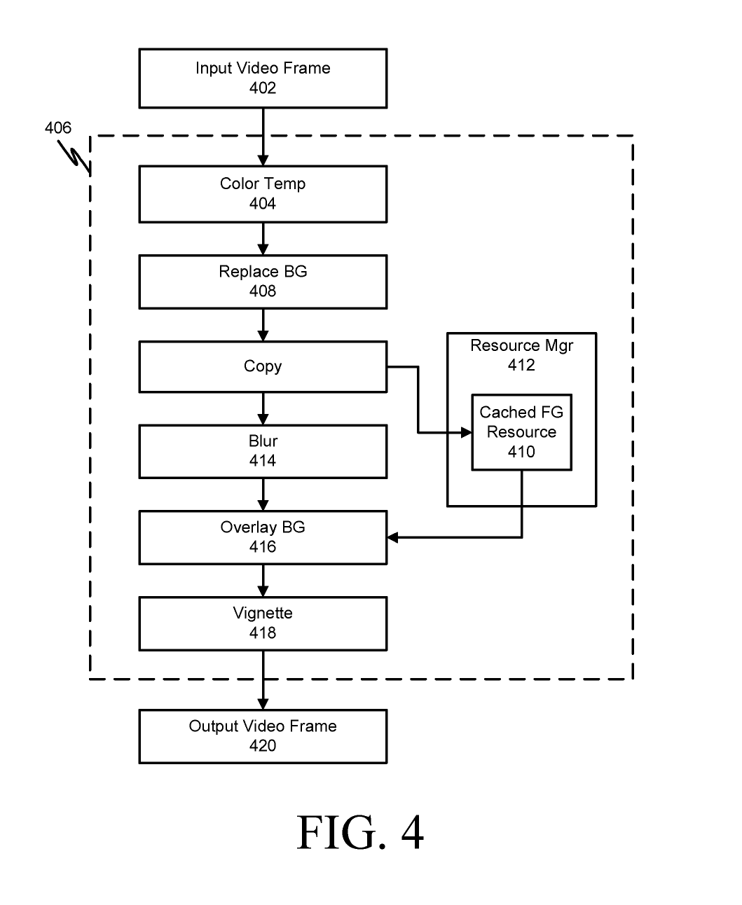

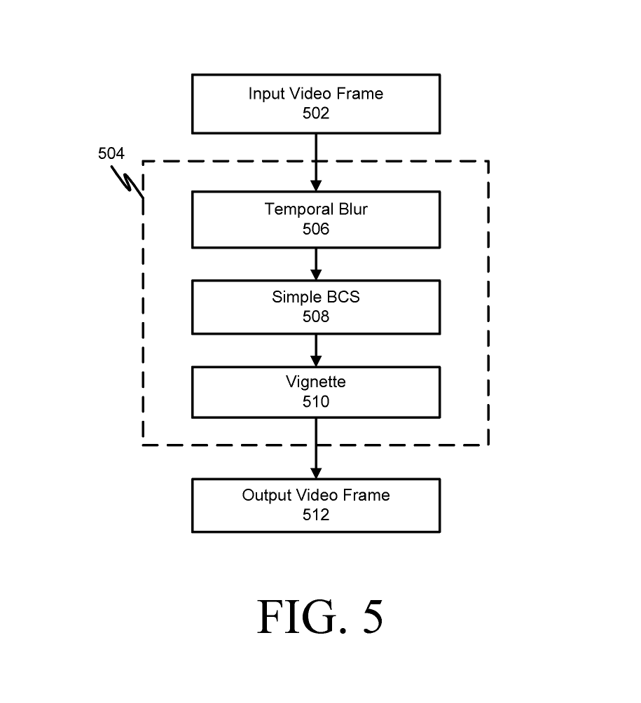

FIGS. 4 and 5 show examples of meta effects. FIG. 4 shows an example “spotlight effect” meta effect. The example spotlight effect includes applying a color temperature adjustment, a heavy background blur and vignetting to video frames. An input video frame 402 is first processed by a color temperature effect 404 of the meta effect 406. Next, a replace background effect 408 is applied, and then a foreground of the image is copied to a cache object 410 in a resource manager 412. Then the frame is blurred 414. The foreground is overlaid 416. The frame is vignetted 418 and the processed frame is outputted 420.

Example JavaScript API code for the spotlight meta effect is as follows:

var metaEffect = gapi.hangout.av.effects.createMetaEffect( );
var color_temp = metaEffect.createSubEffect(“color_temp”,
{“scale”:0.3});
var replace_bg = metaEffect.createSubEffect(“replace_background”,
{ });
var copy = metaEffect.createSubEffect(“copy”, {“resource_key”:“fg”});
var blur = metaEffect.createSubEffect(“blur”, {“window_size”:9});
var overlay_bg = metaEffect.createSubEffect(“overlay_background”,
{“foreground_resource”:{“key”:“fg”}});
var vignette = metaEffect.createSubEffect(“vignetting”, {“size”:0.9});
// Initialize
metaEffect.initEffects([color_temp, replace_bg, copy, blur, overlay_bg,
vignette]);
// Enable
metaEffect.pipelineEffects([color_temp, replace_bg, copy, blur,
overlay_bg, vignette])

Example JSON code for the spotlight meta effect is as follows:

{“init”:[
{“identifier”:“color_temp_1”,“type”:“color_temp”,
“properties”:{“scale”:0.3}},
{“ identifier”:“replace_bg”,“ type”:“replace_background”,
“properties”:{ }},
{“ identifier”:“copy”,“ type”:“copy”,
“properties”:{“resource_key”:“fg”}},
{“ identifier”:“blur_1”,“ type”:“blur”,“properties”:{“window_size”:9}},
{“ identifier”:“overlay_bg”,“type”:“overlay_background”,“properties”:
{“foreground_resource”:{“key”: “fg”}}},
{“ identifier ”:“vignette”,“ type ”:“vignetting”,“properties”:{“size”:0.9}}],
“pipeline”:[
{“ identifier”:“color_temp_1”},
{“ identifier”:“replace_bg”},
{“ identifier”:“copy”},
{“ identifier ”:“blur_1”},
{“ identifier”:“overlay_bg”},
{“ identifier”:“vignette”}
]}

FIG. 5 is an example black and white effect with temporal blur denoising and vignetting. An input video frame 502 is processed by the meta effect 504 by first performing a temporal blur 506. Next, a simple brightness, color, saturation effect 508 is performed. The frame is then vignetted 510 and the processed frame is outputted 512.

Example JavaScript API code for the black and white meta effect is as follows:

var metaEffect=gapi.hangout.ay.effects.createMetaEffect( );

var temporalBlur=metaEffect.createSubEffect(“temporal_blur”, {“learning_rate”:0.9});

var simpleBcs=metaEffect.createSubEffect(“simple_bcs”,

{“brightness”:0.6,“contrast”:0.3,“saturation”:−1.0});

var vignette=metaEffect.createSubEffect(“vignetting”, {“size”:0.9});

metaEffect.initEffects([temporalBlur, simpleBcs, vignette]); //Initialize metaEffect.pipelineEffects([temporalBlur, simpleBcs, vignette]); //Enable

Example JSON code for the black and white meta effect is as follows:

{“init”:[
{“identifier”:“temporal_blur_1”,“type”:“temporal_blur”,
“properties”:{“learning_rate”:0.9}},
{“ identifier”:“simple_bcs_1”,“type”:“simple_bcs”,
“properties”:{“brightness”:0.6,“contrast”
:0.3,“saturation”:−1.0}},
{“ identifier”:“vignetting_1”,“type”:“vignetting”,
“properties”:{“size”:0.9}}
],
“pipeline”:[
{“ identifier”:“temporal_blur_1”},
{“ identifier”:“simple_bcs_1”},
{“ identifier”:“vignetting_1”}
]}

Some implementations of the disclosed method, system, and computer readable media can be implemented in software (e.g., as a computer program product and/or nontransitory computer readable media having stored instructions for configurable media processing with meta effects as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for configurable media processing with meta effects.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
receiving, at one or more processors, one or more effect identifiers;
generating, at the one or more processors, a meta effect object based on the one or more effect identifiers;
receiving, at the one or more processors, a media item including one or more of a video file and an audio file;
processing, at the one or more processors, the media item based on the meta effect, including applying an individual effect operation corresponding to each of the one or more effect identifiers to the media item to generate a processed media file; and
providing, at the one or more processors, the processed media file as output.

2. The method of claim 1, wherein the meta effect object includes a specification of an order in which to apply each effect corresponding to the one or more effect identifiers.

3. The method of claim 1, wherein an effect identifier references another meta effect.

4. The method of claim 1, wherein the other meta effect references an effect identified by one of the effect identifiers.

5. The method of claim 1, further comprising:
providing, at the one or more processors, a resource manager reference for accessing one or more media objects stored in a cache associated with the resource manager.

6. The method of claim 5, wherein each media object in the resource manager cache is accessible via a key, and wherein the key may be shared among effects, including sub effects of an effect.

7. The method of claim 1, wherein the generating includes generating parameters for each effect and including the parameters in the meta effect object.

8. The method of claim 1, wherein the meta effect object is a JSON object.

9. The method of claim 1, wherein the media file includes one or more of a still image, a video file and an audio file.

10. A system comprising:
one or more processors configured to perform operations including:
receiving one or more effect identifiers;
generating a meta effect object based on the one or more effect identifiers;
receiving a media item including one or more of a video file and an audio file;
processing the media item based on the meta effect, including applying an individual effect operation corresponding to each of the one or more effect identifiers to the media item to generate a processed media file; and
providing the processed media file as output.

11. The system of claim 10, wherein the meta effect object includes a specification of an order in which to apply each effect corresponding to the one or more effect identifiers.

12. The system of claim 10, wherein an effect identifier references another meta effect.

13. The system of claim 10, wherein the other meta effect references an effect identified by one of the effect identifiers.

14. The system of claim 10, wherein the operations further include:
providing a resource manager reference for accessing one or more media objects stored in a cache associated with the resource manager.

15. The system of claim 14, wherein each media object in the resource manager cache is accessible via a key, and wherein the key may be shared among effects, including sub effects of an effect.

16. The system of claim 10, wherein the generating includes generating parameters for each effect and including the parameters in the meta effect object, and wherein the meta effect object is a JSON object.

17. A nontransitory computer readable medium having software instructions stored thereon that, when executed by a processor, cause the processor to perform operations comprising:
receiving one or more effect identifiers;
generating a meta effect object based on the one or more effect identifiers;
receiving a media item including one or more of a video file and an audio file;
processing the media item based on the meta effect, including applying an individual effect operation corresponding to each of the one or more effect identifiers to the media item to generate a processed media file; and
providing the processed media file as output.

18. The nontransitory computer readable medium of claim 17, wherein the meta effect includes a specification of an order in which to apply each effect corresponding to the one or more effect identifiers, wherein an effect identifier can be configured to reference another meta effect, and wherein the other meta effect can be configured to reference an effect identified by one of the effect identifiers.

19. The nontransitory computer readable medium of claim 17, wherein the operations further include:
providing a resource manager reference for accessing one or more media objects stored in a cache associated with the resource manager,
wherein each media object in the resource manager cache is accessible via a key, and
wherein the key is shareable among effects, including sub effects of an effect.

20. The nontransitory computer readable medium of claim 17,
wherein the generating includes generating parameters for each effect and including the parameters in the meta effect object, and
wherein the meta effect object is a JSON object.
